(19) United States
(12) Patent Application Publication
(10) Pub. No.: US 2011/0117795 A1
(43) Pub. Date: May 19, 2011

(54) CONNECTOR HOUSING

(75) Inventor: Nobuyuki Sakamoto, Shizuoka (JP)

(73) Assignee: YAZAKI CORPORATION, Tokyo (JP)

(21) Appl. No.: 13/003,893

(22) PCT Filed: Jul. 10, 2009
(86) PCT No.: PCT/JP2009/062621

§ 371 Date: Jan. 13, 2011

(30) Foreign Application Priority Data
Jul. 15, 2008 (JP) 2008-183868

(51) Int. Cl. H01R 13/42

(52) U.S. Cl. 439/746

(57) ABSTRACT

A resin-made connector housing capable of maintaining strength of a lance and preventing a reduction in a terminal holding force even when miniaturization of a connector advances is provided. In the resin-made connector housing in which a flexible lance 20 for retaining and fixing a terminal 1 is disposed inside a terminal receiving chamber 11, the lance is constructed by a cantilever-type arm 20A in which the lance is formed in an L-shaped section including a lateral wall 22 and a vertical wall 23 and the distal end side 29 is formed flexibly in a direction orthogonal to the lateral wall 22 using the proximal end side 28 as a fulcrum. An engaging projection 21 for engaging with the terminal is disposed on an inner surface of the distal end side of the arm, and the engaging projection is formed continuously to both of the lateral wall 22 and the vertical wall 23 constructing the arm.

### TECHNICAL FIELD

The present invention relates to a connector housing including a lance for locking a terminal, the lance being provided in an inner space of a terminal receiving chamber.

### BACKGROUND ART

A general connector is constructed so that a plurality of terminal receiving chambers respectively having flexible lances in the inside thereof are formed in a resin-made connector housing and a terminal inserted into each of the terminal receiving chambers from rear portions thereof is retained and fixed using flexibility of the lance (for example, see Patent Reference 1). The lance of this case is constructed so as to be formed in a flat plate arm shape in which the proximal end side is joined to an inner wall of the terminal receiving chamber and locks the terminal in a removal direction after the terminal is inserted by flexing in a thickness direction of the flat plate.

### PRIOR ART REFERENCE

### Patent Reference

Patent Reference 1: JP-A-2004-14305

### SUMMARY OF THE INVENTION

### Technical Problem

Incidentally, when the connector becomes miniaturization and pitch between the terminals arranged in a lateral direction becomes narrow, a width of the lance also becomes narrow and strength of the lance is reduced, so that a terminal holding force of the lance is reduced. Also, in the case of receiving a plurality of terminals in plural columns in a longitudinal direction, advances in miniaturization of the connector in the longitudinal direction have problems that a wall thickness of the lance also becomes thin and similarly the strength of the lance is reduced and the terminal holding force of the lance is reduced.

In consideration of the circumstances described above, an object of the invention is to provide a resin-made connector housing capable of maintaining strength of a lance and preventing a reduction in a terminal holding force of the lance even when miniaturization of a connector advances.

### Solution to Problem

A connector housing of the invention, comprising:

a terminal receiving portion; and

a flexible lance portion provided in an inner space of the terminal receiving portion for fixing a terminal inserted into the terminal receiving portion to prevent the terminal from dropping out from the terminal receiving portion,

wherein the lance portion has a lateral wall and a vertical wall perpendicular to the lateral wall so that a section of the lateral wall and the vertical wall is formed in substantially an L shape;

wherein a proximal end of the lance portion is supported at the terminal receiving portion so that a distal end of the lance portion can be deformed in a direction perpendicular to the lateral wall; and

wherein an engaging projection for engaging with the terminal is formed at the distal end of the lance portion.

Preferably, the engaging projection is formed so as to be continuous to both of the lateral wall and the vertical wall.

Preferably, the terminal receiving portion and another terminal receiving portion are arranged so as to be adjacent to each other, and the vertical wall of the lance portion is formed as at least a part of a partition wall for partitioning the terminal receiving portion and the another terminal receiving portion.

Preferably, a slit extending in an extension direction of the lance portion is formed on the partition wall so as to separate the vertical wall of the lance portion from a part of the partition wall.

### ADVANTAGEOUS EFFECTS OF INVENTION

According to the above configuration, the lance portion for retaining and fixing the terminal has a cantilever type with the L-shaped section, so that even when the lance portion is formed thinly or narrowly, a rib effect of the vertical wall can maintain high rigidity and also increases resistance to buckling or shear, and a sufficient terminal holding force of the lance portion can be obtained. Therefore, a connector can be miniaturized while maintaining the terminal holding force.

According to the above configuration, the engaging projection, for directly engaging with the terminal, of the distal end of the lance portion is formed on the inner face of the distal end side of the lance portion in a form continuous to both of the lateral wall and the vertical wall, so that resistance to shear fracture is increased as compared with the case of being formed so as to be continuous to only the lateral wall, and the sufficient terminal holding force of the lance portion can be enhanced even when a great removal force acts on the terminal.

According to the above configuration, the vertical wall of the lance portion is used as at least a part of the partition wall (a wall between electrodes) for partitioning the adjacent terminal receiving portions, so that it is unnecessary to provide another partition wall separately and accordingly, an increase in a lateral dimension of the connector housing can be reduced. In other words, the wall (the partition wall) between electrodes is used as the vertical wall of the lance portion, so that the extra increase in the lateral dimension is not caused. Therefore, it can further contribute to miniaturization of the connector.

### BRIEF DESCRIPTION OF DRAWINGS

FIG. 1 is a longitudinal sectional view showing an internal structure of a terminal receiving chamber of a part of a connector housing according to an embodiment.

FIG. 2 is a perspective view of the inside of the terminal receiving chamber seen from the top of a lance.

FIG. 3 is a perspective view of the inside of the terminal receiving chamber seen from the bottom of the lance.

FIG. 4 is a sectional view taken on line IV-IV of FIG. 1.

### DESCRIPTION OF EMBODIMENTS

An embodiment of the invention will hereinafter be described with reference to the drawings.

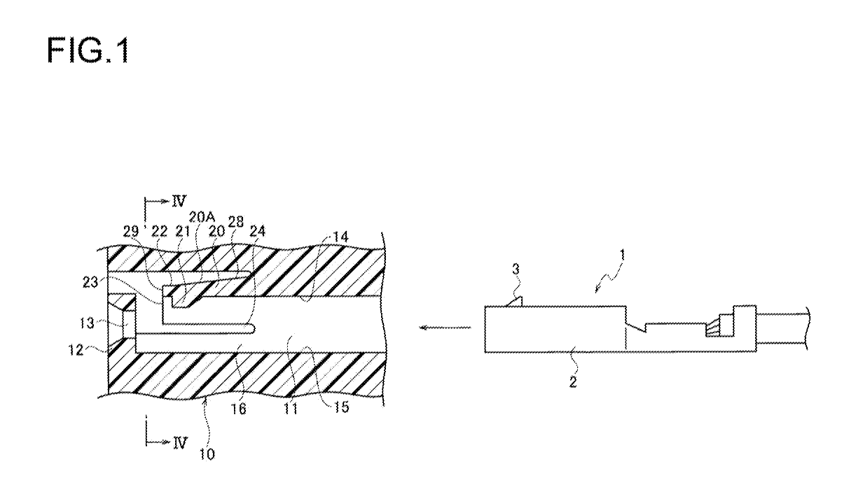

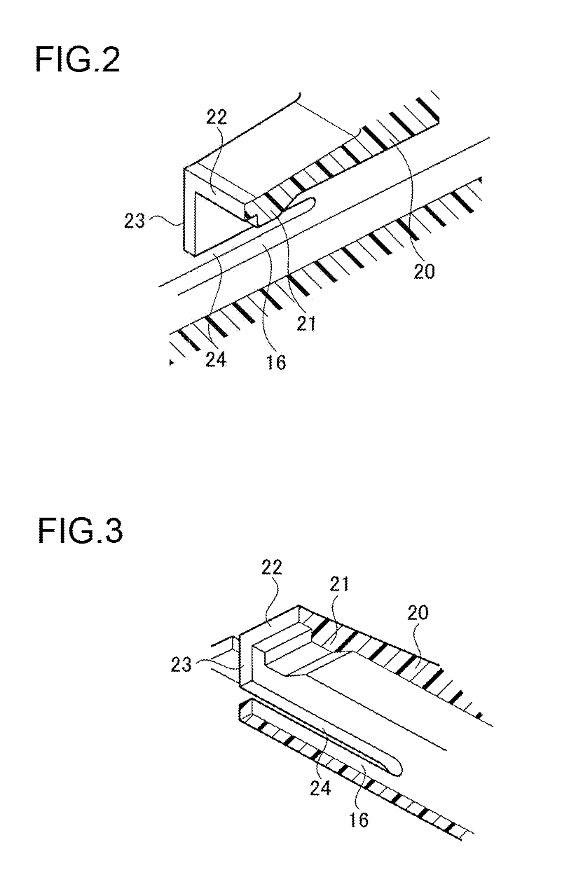

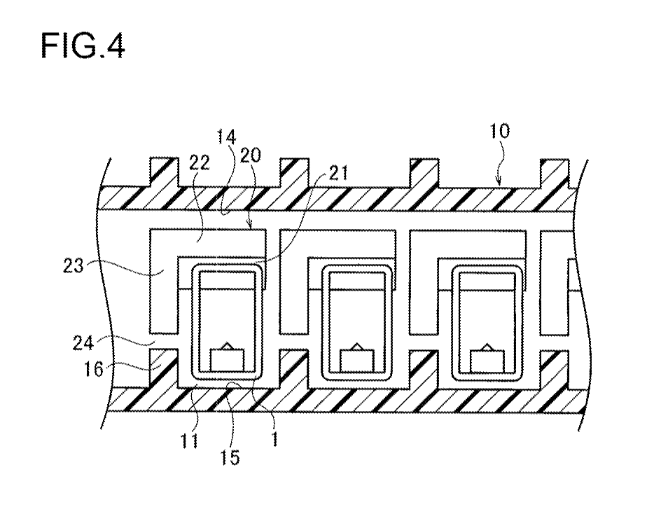

FIG. 1 is a longitudinal sectional view showing an internal structure of a terminal receiving chamber of a portion of a connector housing, FIG. 2 is a perspective view of the inside of the terminal receiving chamber seen from the top of a lance, FIG. 3 is a perspective view of the inside of the terminal receiving chamber seen from the bottom of the lance, and FIG. 4 is a sectional view taken on line IV-IV of FIG. 1.

This connector housing 10 is made of a resin molded product and has a plurality of terminal receiving chambers 11 arranged in a lateral direction. Each of the terminal receiving chambers 11 has a rectangle hole shape. Also, the terminal receiving chambers 11 are disposed in plural steps in a longitudinal direction of the connector housing 10 as necessary. A flexible lance 20 for retaining and fixing a terminal 1 inserted into the terminal receiving chamber 11 from a rear portion thereof is respectively disposed inside each of the terminal receiving chambers 11.

The terminal receiving chamber 11 is a chamber with the rectangle hole shape in which a front end is defined by a front wall 12 having a through hole 13 for receiving a terminal (male terminal) of the other connector, and an upper face, a lower face and a side face are respectively defined by an upper wall 14, a lower wall 15 and a partition wall 16 (a side wall in the terminal receiving chamber of the end), and the lance 20 is provided at a side of the upper wall 14.

The lance 20 includes a lateral wall 22 parallel to the upper wall 14 and a vertical wall 23 orthogonal to the lateral wall 22. The lance 20 is constructed by a cantilever-type arm 20A in which a section of the lateral wall 22 and the vertical wall 23 has an L-shape and the distal end side (front end side of a terminal insertion direction) 29 is deformable in a direction (a vertical direction in the drawing) orthogonal to the lateral wall 22 by using the proximal end side (back end side of the terminal insertion direction) 28 as a fulcrum.

In this case, the plurality of terminal receiving chambers 11 are transversely arranged through the partition walls 16, and a portion of the partition wall 16 for partitioning the adjacent terminal receiving chambers 11 is used as the vertical wall 23 of the arm 20A by being separated via a slit 24.

Also, an engaging projection 21 for engaging with the terminal 1 inserted into the terminal receiving chamber 11 is disposed on an inner face of the distal end side 29 of the arm 20A. The engaging projection 21 is formed continuously to both of the lateral wall 22 and the vertical wall 23 of the arm 20A.

In addition, the terminal 1 of an illustrated example is a female terminal having a box part 2 in the front side thereof, and has an engaged part 3 for engaging with the engaging projection 21 of the lance 20 in an upper portion of the box part 2.

Next, an operation will be described.

When the terminal 1 is inserted into the terminal receiving chamber 11 of this connector housing. 10 from the rear portion thereof, the engaged part 3 of the terminal 1 abuts on the engaging projection 21 and thereby the lance 20 flexes upward, and the engaged part 3 passes and thereby the lance 20 deforms and then returns, and the engaging projection 21 engages with a back face of the engaged part 3. Consequently, the terminal 1 is fixed so as not to be removed backward.

In this case, the lance 20 for retaining and fixing the terminal 1 is constructed by the cantilever-type arm 20A with the L-shaped section, so that even when the lance 20 is formed thinly or narrowly, a rib effect of the vertical wall 23 can maintain high rigidity and also increases resistance to buckling or shear, and a sufficient terminal holding force can be exerted.

Also, the engaging projection 21, for directly engaging with the terminal 1, of the distal end of the lance 20 is formed on the inner surface of the distal end side 29 of the arm 20A with the L-shaped section in a form continuous to both of the lateral wall 22 and the vertical wall 23, so that resistance to shear fracture is increased as compared with the case (conventional form) of being formed so as to be continuous to only the lateral wall 22, and the sufficient terminal holding force can be exerted even when a great removal force acts on the terminal 1.

Also, the vertical wall 23 of the arm 20A constructing the lance 20 is used as at least a part of the partition wall (a wall between electrodes) 16 for partitioning the adjacent terminal receiving chambers 11, so that it is unnecessary to dispose the partition wall separately and accordingly, an increase in a lateral dimension can be reduced. In brief, the wall between electrodes (the partition wall 16) necessary originally is used as the vertical wall 23 of the arm 20A constructing the lance 20, so that the extra increase in the lateral dimension is not caused. Therefore, a connector can be miniaturized while maintaining the terminal holding force.

In addition, in the embodiment described above, the case where the terminal 1 is the female terminal is shown, but the invention can also be applied to the case of a male terminal.

The invention has been described in detail with reference to the specific embodiment, but it is apparent to those skilled in the art that various changes or modifications can be made without departing from the scope of intention or the spirit and scope of the invention.

The invention is based on Japanese patent application (patent application No. 2008-183868) filed on Jul. 15, 2008, and the contents of the patent application are hereby incorporated by reference.

### INDUSTRIAL APPLICABILITY

A resin-made connector housing capable of maintaining strength of a lance and preventing a reduction in a terminal holding force even when miniaturization of a connector advances can be provided.

### DESCRIPTION OF REFERENCE NUMERALS AND SIGNS

1 TERMINAL
10 CONNECTOR HOUSING
11 TERMINAL RECEIVING CHAMBER
16 PARTITION WALL
20 LANCE
20A ARM
21 ENGAGING PROJECTION
22 LATERAL WALL
23 VERTICAL WALL
28 PROXIMAL END SIDE
29 DISTAL END SIDE

1. A connector housing comprising:
a terminal receiving portion; and
a flexible lance portion provided in an inner space of the terminal receiving portion for fixing a terminal inserted into the terminal receiving portion to prevent the terminal from dropping out from the terminal receiving portion,
wherein the lance portion has a lateral wall and a vertical wall perpendicular to the lateral wall so that a section of the lateral wall and the vertical wall is formed in substantially an L shape;
wherein a proximal end of the lance portion is supported at the terminal receiving portion so that a distal end of the lance portion can be deformed in a direction perpendicular to the lateral wall; and
wherein an engaging projection for engaging with the terminal is formed at the distal end of the lance portion.

2. The connector housing according to claim 1, wherein the engaging projection is formed so as to be continuous to both of the lateral wall and the vertical wall.

3. The connector housing according to claim 1, wherein the terminal receiving portion and another terminal receiving portion are arranged so as to be adjacent to each other; and
wherein the vertical wall of the lance portion is formed as at least a part of a partition wall for partitioning the terminal receiving portion and the another terminal receiving portion.

4. The connector housing according to claim 3, wherein a slit extending in an extension direction of the lance portion is formed on the partition wall so as to separate the vertical wall of the lance portion from a part of the partition wall.
